(19) United States
(12) Patent Application Publication
(10) Pub. No.: US 2005/0216704 A1
(43) Pub. Date: Sep. 29, 2005

(54) Device and method for managing a microprocessor instruction set

(75) Inventors: Olivier Ferrand, Carry Le Rouet (FR); Jean-Michel Gril-Maffre, Aix-en-Provence (FR)

Correspondence Address: JENKENS & GILCHRIST, PC, 1445 ROSS AVENUE, SUITE 3200, DALLAS, TX, 75202, US

(73) Assignee: STMicroelectronics S.A., Montrouge (FR)

(21) Appl. No.: 11/083,346

(22) Filed: Mar. 17, 2005

(30) Foreign Application Priority Data
Mar. 22, 2004 (FR) 0402929

(51) Int. Cl. G06F 9/30

(52) U.S. Cl. 712/209

(57) ABSTRACT

A microprocessor has a set of determined instructions which are coded on a determined number P of bits in an instruction coding space of size 2\hat{ }P. The microprocessor includes a mode register having a determined number N of mode bits. A further included decoding unit and an execution unit are arranged so as to decode and execute a given instruction (Iᵢ) according to at least one first or one second mode of execution as a function of the values of a determined number Qᵢ of mode bits associated with the instruction. The instruction corresponds to distinct respective operations in the first mode of execution and in the second mode of execution where Qᵢ is a strictly positive integer.

### PRIORITY CLAIM

This application claims priority from French Application for Patent No. 04 02929 filed Mar. 22, 2004, the disclosure of which is hereby incorporated by reference.

### BACKGROUND OF THE INVENTION

1. Technical Field of the Invention

The present invention relates in a general manner to the management of a microprocessor instruction set. The invention relates more particularly to a microprocessor, as well as to a method of control of such a microprocessor for modifying the nature of the operations coded by the instructions of this microprocessor's instruction set.

2. Description of Related Art

In RISC (“Reduced Instruction Set Computer”) microprocessors, the variety of instructions is limited by the hardware architecture on account of the fact that the instructions must have a fixed size in terms of number of bits. Because the variety of instructions is limited, the user may need to use several instructions to be able to perform a single operation such as, for example, the copying of a memory page into a register. Such an operation requires, for example, the implementation of a software loop where the microprocessor reads a value at a source address in the memory, copies it to a destination address in the register, then increments the source address and the destination address, and if it has not finished running through all the source addresses in the memory, repeats the execution of the corresponding instructions.

To optimize the speed of execution of this software loop, one could imagine supplementing the microprocessor instruction set with instructions, such as, for example, read and write instructions with post-incrementation or post-decrementation of the pointers which point respectively to the source address and the destination address. This is easily possible within the framework of a microprocessor exhibiting a CISC (“Complex Instruction Set Computer”) architecture but is very difficult to achieve within the framework of an RISC microprocessor on account of its reduced instruction set.

Such a software loop contains five instructions, this being expensive in terms of memory space required to store the program of an application implementing the software loop. Now, it is known that a microprocessor occupies the major part of the time to execute software loops in, generally, performing the same type of specific operation as that described above, for example, where only a few instructions are used.

Moreover, it is known that the higher the number of different instructions of the program, the higher the number of instruction cycles during which the microprocessor is monopolized in respect of processing these instructions. This slows down the time of execution of the program by the microprocessor which therefore often performs the same type of operation.

### SUMMARY OF THE INVENTION

To alleviate the aforesaid drawbacks of the prior art, the present invention proposes that the variety of instructions of the microprocessor instruction set be increased by configuring (or modifying) the nature of said instructions, in particular by modifying the operations coded by said instructions.

In a general manner, there is provided a register of N mode bits in such a way as to indicate to the microprocessor several modes of execution of the instructions.

The invention thus relates to a microprocessor having a set of determined instructions which are coded on a determined number P of bits in an instruction coding space. The microprocessor comprises a mode register having a determined number N of mode bits. The microprocessor further comprises a decoding unit and an execution unit, which are arranged so as to decode and execute a given instruction according to at least one first or one second mode of execution as a function of the values of a determined number Qᵢ of mode bits associated with the instruction, the said instruction corresponding to distinct respective operations in the said first mode of execution and in the said second mode of execution, where Qᵢ is a strictly positive integer.

The variety of operations coded by the instructions is thus increased without modifying the size in terms of number of bits of the instructions hence the number of distinct instructions of the instruction set. Everything occurs as if the instruction set comprised additional instructions whereas the instruction coding space remains unchanged.

Moreover, by virtue of the invention, the size of the program in terms of memory space required to store it is reduced and the performance of the microprocessor in terms of speed of execution is improved.

Preferably, each mode bit is associated with at most one instruction. Thus, incompatibilities between modes of execution of distinct instructions are avoided.

Advantageously, at least one configuration instruction of the set of instructions makes it possible to write to the mode register by giving the mode bits values corresponding to the mode of execution of the instruction.

In one embodiment, such a configuration instruction is an initialization instruction, that is to say an instruction for setting to the logic value “1”, having as parameter the value of the address of the mode bit to be programmed. Such an instruction having just a single parameter may be coded on a relatively large number of bits in an RISC architecture, allowing a more varied set of instructions.

In this case, another configuration instruction is provided for in the form of a reinitialization instruction, that is to say an instruction for setting to the logic value “0”, having as parameter the value of the address of the mode bit to be programmed.

In another embodiment, the configuration instruction is a load instruction having as parameters the value of the address of the mode bit to be configured and the value (0 or 1) to be given to the said mode bit. A single instruction is therefore sufficient to program a mode bit. Moreover, it is coded on a relatively small number P of bits in an RISC architecture, thereby limiting the number of instructions of the instruction set.

In an embodiment where the invention is particularly advantageous, the microprocessor exhibits an RISC architecture.

Advantageously, the mode register may be internal to the microprocessor. The access times are reduced, thereby speeding up the execution of the programs.

The invention also relates to a method of managing a microprocessor of the type described above, the method comprising a step according to which the execution unit executes a given instruction according to at least one first or one second mode of execution as a function of the values of a determined number Qᵢ of mode bits associated with the instruction, said instruction corresponding to distinct respective operations in said first mode of execution and in said second mode of execution, where Qᵢ is a strictly positive integer.

In accordance with an embodiment of the invention, an apparatus comprises a computation unit for a microprocessor and a register storing at least one mode bit associated with a certain program instruction. A decoding unit is operable to interpret program instructions and control operation of the computation unit according to those instructions, the certain program instruction corresponding to at least two different operations to be performed by the computation unit based on the value of the at least one mode bit.

In accordance with another embodiment, an apparatus comprises a computation unit for a microprocessor having a set of program instructions and a register storing at least one mode bit associated with a certain one of those program instructions. A decoding unit is operable to control the computation unit to execute that certain program instruction in a first mode of execution if the mode bit has a first value and operable to execute that certain program instruction in a second, distinct, mode of execution if the mode bit has a second value.

In accordance with another embodiment, a method for use with a microprocessor having a set of program instructions comprises storing at least one mode bit associated with a certain one of those program instructions. Execution of that certain program instruction is controlled in a first mode of execution if the mode bit has a first value. Execution of that certain program instruction is controlled in a second, distinct, mode of execution if the mode bit has a second value.

### BRIEF DESCRIPTION OF THE DRAWINGS

Other characteristics and advantages of the invention will become further apparent on reading the description which follows. The latter is purely illustrative and should be read in conjunction with the appended drawings, in which:

FIG. 1 is a functional diagram illustrating one embodiment of a microprocessor according to the present invention;

FIG. 2 illustrates a portion of mode register according to one embodiment of the present invention;

FIG. 3 illustrates an example of a portion of program for storing values in a register on the basis of a memory according to one embodiment of the present invention; and

FIG. 4 illustrates an example of a portion of program for storing values in a register on the basis of a memory according to a procedure known in the state of the art.

### DETAILED DESCRIPTION OF THE DRAWINGS

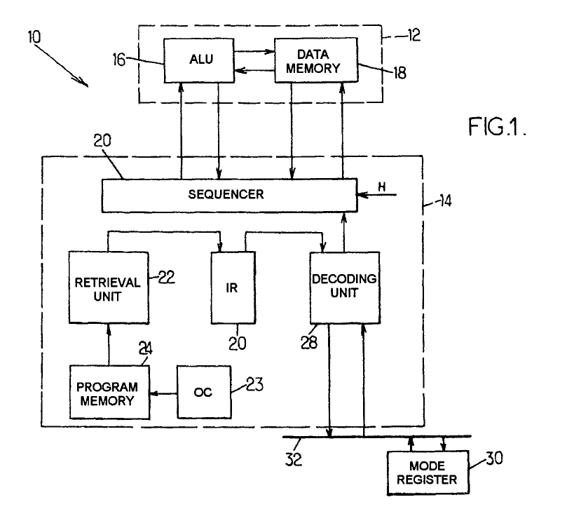

With reference to FIG. 1, the microprocessor 10 comprises an execution unit 12 which includes an arithmetic and logic unit 16 (ALU) for performing elementary operations such as additions, multiplications or the like and which comprises logic units performing the elementary operations such as adders, multipliers or the like, each elementary operation being coded by an instruction of the microprocessor instruction set.

The execution unit 12 further comprises a data memory 18, such as, for example, registers or/and memories, for storing data specific to the various elementary operations performed such as for example the result of an elementary operation.

The microprocessor 10 comprises a control unit 14 for interpreting the instructions of a program being executed and for controlling the arithmetic and logic unit 16 accordingly.

The control unit 14 comprises for example:
a sequencer 20 which generates, in tempo with the cycles of a clock signal H, control signals delivered to the various logic units of the computation unit 12 which participate in the execution of a given instruction;
a fetch unit 22 which retrieves an instruction to be executed from a program memory 24 in which the program is stored, such as for example a memory of ROM (“Read Only Memory”) type, flash EPROM (“Erasable Programmable Read/Only Memory”) type or EEPROM (“Electrical EPROM”) type;
an ordinal counter 23 (OC) which is a register storing the address of the next instruction to be executed;
an instruction register 26 for sequentially storing the instructions to be executed;
a decoding unit 28 for interpreting and decoding the instructions to be executed and determining, in response to the decoding, the elementary operations to be performed, more precisely determining the logic units to be controlled so as to perform these elementary operations.

The microprocessor 10 further comprises a mode register 30 of N bits, called mode bits, the mode register 30 being internal or external to the microprocessor 10 and N being a strictly positive integer.

The microprocessor 10 also comprises a bus 32 for reading the values of the mode bits of the mode register 30 and for transmitting the values read to the decoding unit 28.

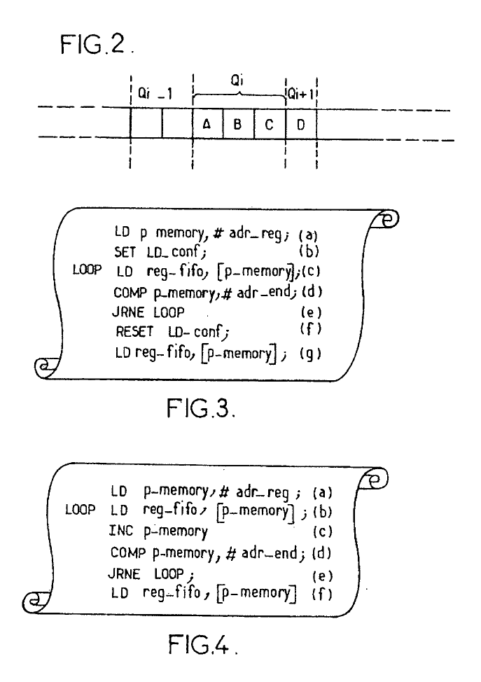

Each instruction “Iᵢ” is associated with Qᵢ mode bits such as is illustrated in FIG. 2 where Qᵢ is a strictly positive integer. Stated otherwise, each instruction is executed according to at least one first and one second mode of execution for which the instruction codes distinct operations. Stated otherwise, the nature of the instruction is distinct from one mode to the other.

Thus, the state of the Qᵢ mode bits indicates to the microprocessor 10, in particular to the decoding unit 28, the mode of execution of the instruction “Iᵢ” to be implemented.

For example, as illustrated in FIG. 2, the instruction “Iᵢ” is associated with the Qᵢ mode bits, namely three bits. A, B and C. Such an instruction “Iᵢ” may thus be executed according to at most 2\hat{ }A₃ modes of execution. The maximum number of modes of execution of this instruction is of course defined by the designer.

Likewise, the instruction “Iᵢ₊₁” is associated with the Qᵢ₊₁ mode bit, that is to say the bit D. The instruction “Iᵢ₊₁” can thus be executed according to at most 2\hat{ }1 modes of execution.

Every-thing occurs therefore as if there were additional instructions in the microprocessor instruction set, whereas in reality the number of instructions of the instruction set remains fixed.

Specifically, for a given instruction “Iᵢ” coded on a determined number P of bits in an instruction coding space of size 2\hat{ }P and associated with a number Qᵢ of mode bits, the instruction set is akin to an instruction set to which 2\hat{ }Qᵢ−1 instructions have been added. Of course, the maximum number of distinct instructions of the instruction set is in reality still equal to 2\hat{ }P.

Stated otherwise, the variety of operations coded by each instruction can be increased without thereby increasing the size in terms of number of bits of the said instruction, which must remain fixed within the framework of RISC microprocessors.

To modify the mode of execution of instruction “Iᵢ”, a configuration instruction makes it possible to modify the values of the Qᵢ mode bits associated with the said instruction.

In one embodiment, the programming of the mode bits may be performed via an initialization instruction “SET” and/or a reinitialization instruction “RESET” having the address of the mode bit as value specified as parameter. For example, the initialization instruction sets the state of a mode bit to the logic value “1” and the reinitialization instruction sets the state of the mode bit to the logic value “0”.

In another embodiment, the configuration instruction is a load instruction having as input parameters the address of the mode bit whose state one wishes to modify and the value of the state that one wishes to give it.

Thus, to ascertain the mode of execution of the instruction “11”, the decoding unit 28 is configured in mode register read mode. By way of the bus 32 it reads the values of the Qᵢ mode bits associated with the instruction “Iᵢ” currently being decoded and intended to be executed.

As a function of the values of the Qᵢ mode bits, the decoding unit 28 and the execution unit 12 implement the appropriate mode of execution of the instruction “Iᵢ”. The determined mode of execution is implemented so long as the values of the Qᵢ mode bits remain unchanged.

The selection of the mode bits to be read by the decoding unit 28, that is to say the Qᵢ mode bits associated with the instruction “Iᵢ” currently being decoded is carried out by the decoding of the code of the said instruction. In particular, the decoding of the code of the instruction “Iᵢ” indicates to the decoding unit 28 the values of the Qᵢ mode bits to be read.

FIG. 3 illustrates an example of a portion of program for storing data in a register on the basis of data stored in a memory according to an embodiment of the present invention.

The object of this portion of program is to store the content of a memory in a FIFO register referenced “reg_fifo” in the program by way of a software loop comprising a load instruction referenced “LD” in the program and for which one wishes to modify the nature of the operation that it codes and whose associated mode bit is referenced “LD_conf” in the program.

The start address and the end address of the memory are respectively referenced “adr_beg” and “adr_end” in the program. The address of the memory is pointed at by the pointer referenced “p_memory” in the program.

To store the data of the memory, all the addresses of the said portion of the memory are run through, incrementing the address pointed at by the pointer “p₁₃ memory”.

By comparison, an incrementation instruction INC can also be used to increment the address pointed at by the pointer as is illustrated in FIG. 3 (line “j”). In this example, the incrementation instruction is processed at each iteration of the software loop, this monopolizing a clock signal cycle for the processing of said instruction by the control unit and this being expensive in terms of memory space storing the program.

Through the present invention, the aforesaid constraints are circumvented by modifying the nature of the operation coded in the load instruction. More precisely, the load instruction is indicated to the microprocessor 10, in particular the decoding unit 28, as being a post-incremented load instruction, that is to say that for each iteration of the software loop, the address of the memory pointed at by the pointer “p_memory” is incremented automatically.

The program thus comprises an initialization instruction “SET” for initializing the mode bit referenced “LD_conf” associated with the load instruction. For example, the initialization instruction sets the value of the mode bit to the logic value “1”.

Thus, during the decoding of the load instruction for each iteration of the software loop, the decoding unit reads the state of the associated mode bit in the mode register to determine according to which mode of execution the load instruction is to be executed.

The nature of the operation coded by the load instruction is modified and comprises in addition to its initial function, namely to load a data item into a memory space (here a register), the function of post-incrementation of the address of the memory pointed at by the pointer “p_memory”.

When all the data are copied from the memory into the register, a reinitialization instruction “RESET” is executed to reinitialize the mode bit of the load instruction and to indicate to the microprocessor that it can again execute the load instruction according to the normal mode of execution. For example, the reinitialization instruction sets the value of the mode bit to the logic value “0”.

More precisely, in the subsequent execution of the program, the operation coded by the load instruction has as function to load data into a specific location but no longer carries out the post-incrementation function.

An advantage of the invention is understood here, according to which the program is of reduced size and of reduced execution time as compared with the procedure of FIG. 4.

For example, to store 1000 values in the register on the basis of 1000 values stored in the memory according to the procedure of the state of the art with the aid of a software loop, the microprocessor executes 4002 operations, whereas according to the embodiment of the present invention, the microprocessor executes 3004 operations (i.e., a reduction of 25% of the operations to be executed by the microprocessor and consequently an increase in the performance of the said microprocessor in terms of speed of execution of the program). This advantage is all the more beneficial as microprocessors execute a very large number of software loops of this type.

Of course, the embodiment given above by way of example is not limiting. It is possible to modify the nature of the operations of each instruction of the set of instructions of the microprocessor, each instruction being executable according to several modes of execution. For example, in the example described above, it is possible to also assign the function of loading with post-decrementation to the load instruction.

Moreover, the size in terms of number of bits of the instructions of the microprocessor is nonlimiting and can take any value whatsoever, for example 8 bits, 16 bits, 32 bits or more.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A microprocessor having a set of determined instructions which are coded on a determined number P of bits in an instruction coding space of size 2\hat{ }P, comprising:
a mode register having a determined number N of mode bits;
a decoding unit and an execution unit which are arranged so as to decode and execute a given instruction (Iᵢ) according to at least one first or one second mode of execution as a function of the values of a determined number Qᵢ of mode bits associated with the instruction, said instruction corresponding to distinct respective operations in said first mode of execution and in said second mode of execution, where Qᵢ is a strictly positive integer.

2. The microprocessor according to claim 1, wherein each mode bit is associated with at most one instruction of the set of instructions.

3. The microprocessor according to claim 1, wherein the set of instructions comprises at least one configuration instruction of the set of instructions which makes it possible to configure the mode register by giving the mode bits values corresponding to the mode of execution of the instruction (Iᵢ).

4. The microprocessor according to claim 3, wherein a configuration instruction is an initialization instruction having as parameter the value of the address of the mode bit to be programmed.

5. The microprocessor according to claim 4, wherein another configuration instruction is a reinitialization instruction having as parameter the value of the address of the mode bit to be programmed.

6. The microprocessor according to claim 3, wherein a configuration instruction is a load instruction having as parameters the value of the address of the mode bit to be programmed and the value to be given to said bit.

7. The microprocessor according to claim 1, wherein the microprocessor exhibits an RISC architecture.

8. The microprocessor according to claim 1, wherein the mode register is internal to the microprocessor.

9. A method of managing a microprocessor having a set of determined instructions which are coded on a determined number P of bits in an instruction coding space of size 2\hat{ }P, the microprocessor having a mode register having a determined number N of mode bits, a decoding unit and an execution unit which are arranged so as to decode and execute given instructions, the method comprising:
execution by the execution unit of an instruction (Iᵢ) according to at least one first or one second mode of execution as a function of the values of a determined number Qᵢ of mode bits associated with the instruction, said instruction corresponding to distinct respective operations in said first mode of execution and in said second mode of execution where Qᵢ is a strictly positive integer.

10. The method according to claim 9, further comprising configuring the mode register via a configuration instruction by giving the mode bits values corresponding to the mode of execution of the instruction (Iᵢ).

11. The method according to claim 10, wherein a configuration instruction is an initialization instruction having as parameter the value of the address of the mode bit to be programmed.

12. The method according to claim 11, wherein another configuration instruction is a reinitialization instruction having as parameter the value of the address of the mode bit to be programmed.

13. The method according to claim 10, wherein a configuration instruction is a load instruction having as parameters the value of the address of the mode bit to be programmed and the value to be given to said bit.

14. An apparatus, comprising:
a computation unit for a microprocessor;
a register storing at least one mode bit associated with a certain program instruction; and
a decoding unit operable to interpret program instructions and control operation of the computation unit according to those instructions, the certain program instruction corresponding to at least two different operations to be performed by the computation unit based on the value of the at least one mode bit.

15. The apparatus of claim 14 wherein Qi>1 mode bits are associated with the certain program instruction, that certain program instruction corresponding to 2\hat{ }Qi different operations to be performed by the computation unit based on the value of the mode bits.

16. The apparatus of claim 14 wherein a plurality of program instructions are each associated with at least one mode bit, and at least two different operations are specified by the value of the associated at least one mode bit.

17. An apparatus, comprising:
a computation unit for a microprocessor having a set of program instructions;
a register storing at least one mode bit associated with a certain one of those program instructions; and
a decoding unit operable to control the computation unit to execute that certain program instruction in a first mode of execution if the mode bit has a first value and operable to execute that certain program instruction in a second, distinct, mode of execution if the mode bit has a second value.

18. A method for use with a microprocessor having a set of program instructions, comprising:
storing at least one mode bit associated with a certain one of those program instructions;
controlling execution of that certain program instruction in a first mode of execution if the mode bit has a first value; and
controlling execution of that certain program instruction in a second, distinct, mode of execution if the mode bit has a second value.
